(19) United States
(12) Patent Application Publication
(10) Pub. No.: US 2011/0266849 A1
(43) Pub. Date: Nov. 3, 2011

(54) APPARATUS FOR ADJUSTING THE HARDNESS AND GEOMETRY OF SEATING ELEMENTS OF A MOTOR VEHICLE SEAT

(76) Inventor: Peter Schwarze, Leipzig (DE)

(21) Appl. No.: 13/143,013

(22) PCT Filed: Dec. 16, 2009
(86) PCT No.: PCT/DE09/01776

§ 371 Date: Jun. 30, 2011

(51) Int. Cl. F16H 25/16; B60N 2/44; F16H 25/20

(52) U.S. Cl. 297/284.1; 74/89; 74/89.23

(57) ABSTRACT

An apparatus for adjusting the hardness and geometry of seating elements of a motor vehicle seat, in particular for adjusting the curvature and/or width of side bolsters of a seat bottom or a backrest, of an upper rest part of a divided backrest, a lumber support or thigh rest of a seat bottom having supporting wings, the position of which can be changed by way of pivotable actuating elements is provided. The actuating elements are part of an adjustment module for adjusting the seating element, said module comprising a carrying element which can be connected to the seating element and on which the actuating element is pivotably mounted and can be adjusted along a control curve by means of a spindle drive connected to the carrying element.

### CROSS-REFERENCE TO A RELATED APPLICATION

This application is a National Phase Patent Application of International Patent Application Number PCT/DE2009/001776, filed on Dec. 16, 2009, which claims priority of German Utility Model Application Number 20 2009 000 559.3, filed on Jan. 9, 2009.

### BACKGROUND

The invention relates to an apparatus for adjusting the hardness and geometry of seating elements of a motor vehicle seat.

The object of the invention serves to variably change the form of a supporting area or a side bolster of the seat bottom or the back rest of a motor vehicle seat, in particular for adjusting the curvature and/or width of lateral supporting areas or side bolsters of a seat bottom or a backrest, the supporting area of an upper rest part of a divided back rest in the shoulder and head area of an occupant, a lumbered support in lumber vertebra area of an vehicle occupant or a thigh rest of a seat bottom. Thereby the width of a seat bottom or the back rest is influenced by the adjustment of the hardness and geometry of a lateral supporting area or side bolster and is therefore also adjustable so that the lateral supporting area or side bolster of the seat bottom or the back rest itself can be mounted rigidly to the seat bottom or the back rest.

An adjustment of the seat width for a motor vehicle seat with lateral supporting wings being hinged to the seat part and/or to the back rest in a opposing pivotable manner is known from the DE 197 37 271 C1, wherein said supporting wings can be pivoted by means of twistable curve areas of actuating elements resting against the supporting wings. The actuating elements on their part can be pivoted by means of cable pulls moved by a control gear.

An adjustment for the seat width is known from the DE 90 14 111 U1, in which the geometry of a side bolster is solely adjusted pneumatically by means of an inflatable spring bellow. Due to the decrease of the internal pressure of the inflatable spring bellow the once adjusted geometry is however being lost over time.

It is known from the DE 20 2005 006 988 U1 to influence the shape of the side bolster of a vehicle seat by changing the deflection of a spring element, which acts on a hinged side wing. A free end of a spring element can be moved for this reason by means of an adjusting element.

It is known from DE 197 50 116 C2 to provide a holder being pivotable against the spring force for influencing the shape of side bolster of a vehicle seat. The deflection of the holder occurs via a pull tap acting on the holder, wherein said pull tap is to be actuated via a pull cable. The holders are made of spring steel and can be twisted at their mounting positions.

### SUMMARY

It is an object of the present invention to provide an apparatus of the previously mentioned kind which has a simple construction, guarantees a secure operation and can be manufactured at low costs.

The solution according to the invention provides a simple constructed apparatus for adjusting the hardness and geometry of seating elements of a motor vehicle seat, in particular for adjusting the curvature and/or width of side bolsters of a seat bottom or back rest, an upper rest part of a divided back rest, a lumber support or a thigh rest of a seat bottom, which guarantees a safe operation and can be manufactured at low costs. The solution according to the invention allows it in particular to adjust lateral supporting areas or side bolsters of different construction by standard means in a dimensionally stable manner and without the requirement of a free standing movable side bolster, wherein the standard means are also suited to adjust other seating elements of a motor vehicle, so that a further reduction of manufacturing costs by using the same components is possible.

When adjusting the hardness and geometry of seating elements of a motor vehicle seat, in particular the seat side parts or side bolsters of the seat bottom or a back rest, also an adjustment of a motor vehicle seat as a comfortable seat with soft, flexible side parts or as a sport seat with hard side parts resting tightly against the body of the vehicle occupant is possible.

Due to the axis-symmetrical design of the adjustment module such that it can be used for a right and for a left vehicle side, the application range of the adjustment module is increased and mistakes during assembly due to the use of unsuited adjustment modules is prevented.

The spindle drive of the adjustment module comprises exemplary a spindle, which can be driven by a drive mechanism, wherein said spindle combs with a spindle nut, which is connected to a slider being translational guided, in particular on a guide rail of the carrying element, wherein on said slider the actuating element pivotably mounted on the carrying element is supported, while the control curve consists of ramp sections, which are formed on the slider and/or on the actuating element.

This modification of a spindle drive for the adjustment module is characterized by flat and therefore space saving construction and guarantees the uptake or transfer of large forces and allows a simple adjustment of the shape as well as the adjustment of width and hardness of a seating element of the motor vehicle seat due to the shaping of ramp sections on the slider or on on the actuating element. Therewith the effect of an inflatable spring bellow can be reproduced by mechanical means without that the disadvantages of the pneumatic inflation of a decreasing internal pressure and therefore a loss of the adjusted geometry occur. Furthermore, no stability structure of the seat bottom or the back rest of the motor vehicle seat is required, which allows for a free standing movable side bolster.

In a kinematic reversion of the previous embodiment the spindle drive comprises alternatively a spindle, which can be driven by a drive mechanism, wherein said spindle combs with a spindle nut, wherein said spindle nut is connected to the actuating element being translational guided and pivotably arranged on the carrying element, wherein said actuating element is supported on a stationary slider. The stationary slider is preferably connected to the seat body or the carrying element and is for instance arranged at the lateral end of the carrying element.

This alternative embodiment allows for a kinematics when actuating the spindle drive deviating from the previous embodiment. While the actuating element in the previous embodiment, when displacing the spindle nut from the end of the carrying element for hinging the actuating element, carries out a pivot movement depending solely on the geometry of the actuating element around the hinging, the actuating element is lateral adjusted during the kinematic reversal, when displacing the spindle nut from the inner to the outer end of the carrying element, and is marginally pivoted in order to be pivoted stronger towards the front, that means away from the back surface of the back rest, when approaching the stationary slider. Therefore, the kinematics of the course of motions can be determined by the selection of the embodiment.

The actuating element consists preferably of a wire holder having two arms, the end of which are hinged pivotably to swivel bearings connected to the carrying element, for a weight reduction and a simple design of a ramp section for the control curve of the adjustment module.

In order to distribute the mechanically produced pressure of an adjustment module flatly in the seat element, that means in the respective supporting area or in the side bolster of the seat bottom or the back rest of a motor vehicle seat, the supporting wings consist of flexible, that means elastic deflectable plastic shields, flexible mats or hardenings in the cushion foam, which can be for instance formed in that plastics with different degrees of hardness are used or hardening fillers are introduced into the cushion foam.

Due to a movable connection between the supporting wings and the actuating elements on the one hand motion compensation is possible when actuating the adjustment module, and on the other hand the ergonomic feeling of certain elasticity in the area of the side bolsters is obtained.

In order to control the hardness and geometry of the seating elements of a motor vehicle seat, the supporting wings can be connected via guiding devices to the seating elements or stability structure of the seat bottom or the back rest of the motor vehicle seat.

For an individual adjustment of shape and hardness of the right and left side bolsters of the motor vehicle seat, each side bolster can be connected to an adjustment module with its own drive mechanism of the spindle drive. When coupling the two independent drive mechanisms aacordingly, then also a uniform modification of the two side bolsters can be obtained. This coupling can occur in case of an electromotive drive mechanism for instance by a simultaneous control of the independent drive mechanisms for the spindle drives of the adjustment modules.

A uniform modification of both side bolsters of a seat bottom or a backrest of a motor vehicle seat can however also be obtained by an adjustment module for adjusting supporting wings being arranged in both side bolsters of the motor vehicle seat by means of a common spindle drive, wherein the carrying element comprises guide rails or is connected to guide rails, on which the slider of the adjustment module for adjusting the hardness and/or geometry or the curvature and/or the width of right and left side bolsters of a motor vehicle seat are movably guided in directions opposite to each other and the spindle drive or the adjustment module includes a spindle with two thread sections with a thread pitch opposing each other, which combs with two spindle nuts connected in each case to a slider such that the sliders are movable, when rotating the spindle in directions opposing each other, and via the ramp sections formed on the sliders and/or on the actuating element the actuating elements pivot about the swivel bearing.

Manual as also electromotive drives can be used as drive mechanisms for the spindle drive of the adjustment modules. A manual drive can be for instance designed in a way of an adjustable backrest inclination with a knob in connection to a self-locking gear, for instance a wobble gear.

### BRIEF DESCRIPTION OF THE DRAWINGS

The idea of the invention shall be explained in more detail by means of the embodiments shown in the drawings.

FIG. 1 shows a schematic perspective illustration of a back rest of a motor vehicle seat with side bolsters and an apparatus for adjusting the geometry and hardness of the side bolsters.

FIG. 2 shows an enlarged perspective illustration of the apparatus for adjusting the geometry and hardness of the side bolsters.

FIGS. 3 and 4 show perspective illustrations of adjustment modules for adjusting the geometry and hardness of the side bolsters in different adjustment positions.

FIGS. 5 and 6 show a perspective top view on the backrest with different positions of supporting wings adjustable by means of the adjustment module for different geometries and/or hardness or curvature and/or width of a side bolsters of the back rest.

### DETAILED DESCRIPTION

In the perspective illustrations the same or correlating parts of the apparatus according to the invention are provided in each case with the same references, wherein right and left parts of a module vehicle seat do only differ from each other by apostrophes.

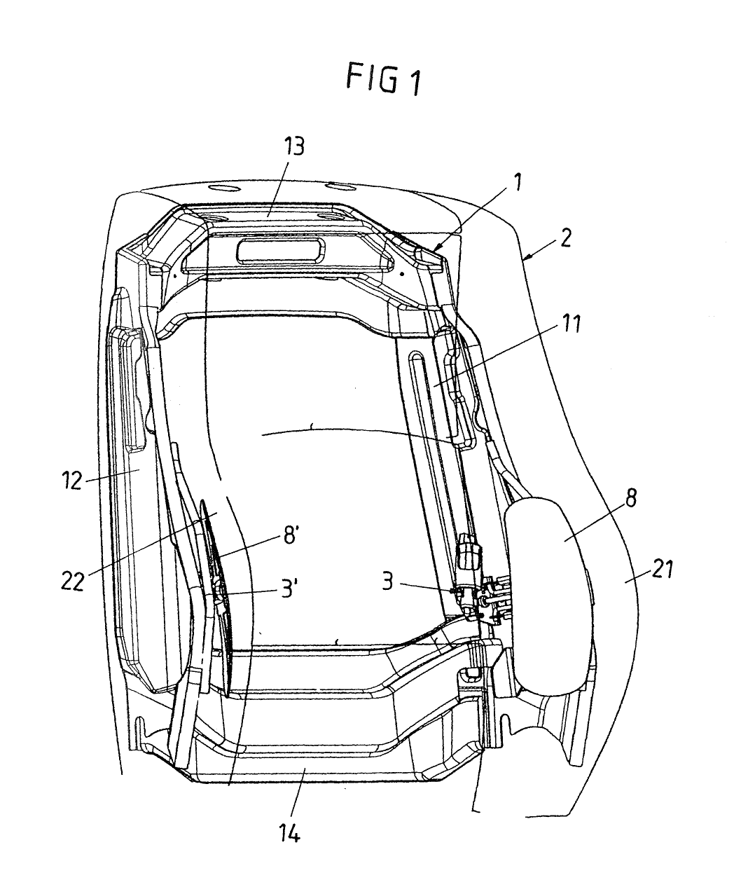

The back rest of a motor vehicle seat illustrated in a perspective manner in FIG. 1 comprises a backrest frame 1 determining the stability structure of the back rest with side members 11, 12 and an upper cross-member 13 connecting the side members 11, 12 as well as the lower side member 14, which is connected in a known manner via an adjustable inclination to a seat bottom of a motor vehicle seat. The back rest frame 1 is surrounded by a schematically drafted cushion 2 and forms side bolsters 21, 22 on the side members 11, 12, wherein said side bolsters support the upper body of a vehicle occupant in case of forces arising in vehicle cross direction. In order to be able to adapt these usually rigid designed side bolsters 21, 22 optimal to the upper body of the vehicle occupant an apparatus for adjusting the geometry and/or hardness of the side bolsters 21, 22 is provided with which the respective geometry, that means curvature and/or width, as well as hardness of the side bolsters 21, 22 can be adjusted lasting and independent on the external forces acting on the side bolsters 21, 22.

The adjustment apparatus comprises an adjustment module 3, 3′, which is used independently from the respective seating element of the motor vehicle seat to be adjusted, that means for adjusting the geometry and/or hardness or the curvature and/or the width of side bolsters of the seat bottom or backrest, an upper rest part of a divided back rest, a lumber support or a tigh rest of a seat bottom etc. The adjustment module 3, 3′ serves for adjusting supporting wings 8, 8′, which distribute extensively the adjustment force and setting force of the adjustment module 3, 3′ to the side bolsters 21, 22 so that no local pressure forces act onto the upper body of the vehicle occupant (or when using on side bolsters of a seat bottom on the thighs of a vehicle occupant or when using on the upper rest part of the divided back rest on the shoulder portion of the motor vehicle occupant). The supporting wings 8, 8′ can for instance consist of flexible plastic shields, flexible mats or hardenings in the cushion foam of the side bolsters 21, 22, wherein hardenings in the cushion form can be formed for instance by using different plastics in the cushion 2 or corresponding inserts in the cushion 2.

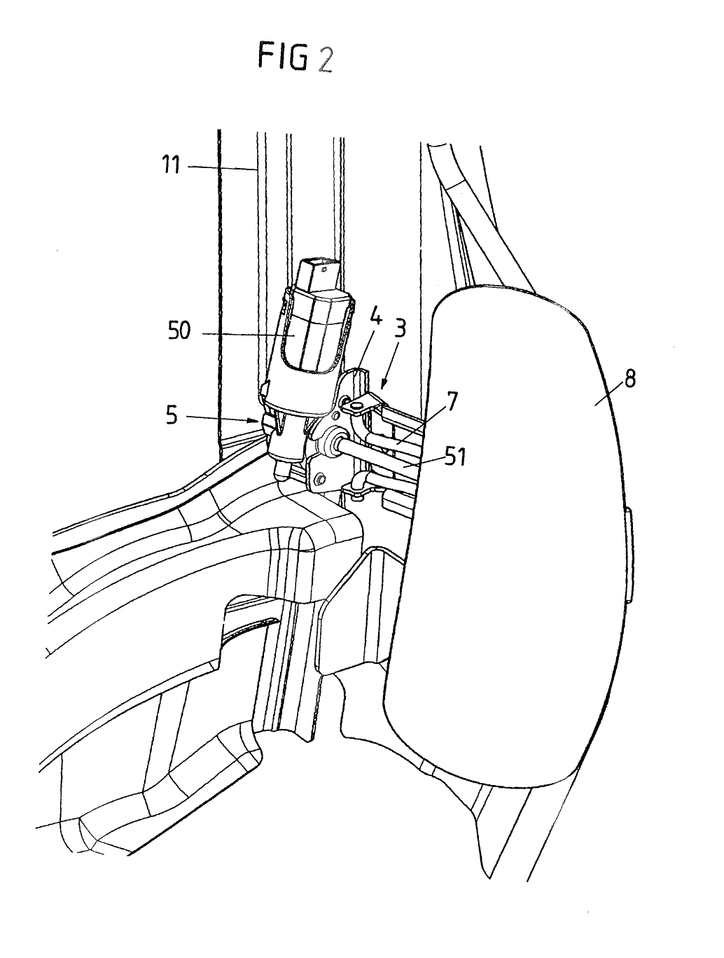

The adjustment modules 3, 3′ for adjusting the position or direction of the supporting wings 8, 8′ and therefore for adjusting the geometry and/or hardness or the curvature and/or width of side bolsters 21, 22 comprise according to the FIGS. 2 to 4 a carrier element 4 connected to the backrest frame 1 or to the side member 11 of the backrest frame 1, a spindle drive 5 as well as an actuating element 7 in form of a wire holder with two arms 71, 72, which can be pivoted by means of the spindle drive 5, wherein the bent end sections thereof formed as bearing sections 73, 74 are pivotably hinged on swivel bearings 43, 44 of the carrying element 4.

In order to guarantee a possibly required motion compensation between the actuating element 7 and the supporting wings 8, 8′ a movable connection between the actuating elements and the supporting wings 8, 8′ is provided for instance in form of Velcro fasteners.

The spindle drive 5 consists of an electromotive drive mechanism 50 with an electromotor, a gear, a receiving housing and a connector 53, a spindle 51 driven by the electromotive drive mechanism 50 and a spindle nut 52 combing the spindle 51, which are tightly connected to a slider 6, which is movably mounted in longitudinal direction of the carrying element 4 on bent guide rails 41, 42 of the carrying element 4. Alternatively, the spindle nut 52 can also be formed in one piece in the slider 6 or can be connected to said slider.

The adjustment module 3 shown in the FIGS. 2 to 4 is constructed such that it can be used axissymmetrically, that means for the left and right side bolster of a motor vehicle seat or for the adjustment of the geometry and/or hardness of a thigh rest, an upper back rest part of a divided backrest or a lumber support.

The wire holder 7 is not formed flat but curved so that a ramp section 70 is defined with a variable curve, wherein said ramp section interacts in combination with guide notches 61, 62 of the slider 6. The slider 6 is guided on the guide rails 41, 42 of the carrying element 4 in extension direction of the arms of the U-shaped actuating element 7 and engages with its guide notches 61, 62 beneath the two arms of the actuating element 7 on its curved ramp section 70 for guiding the arms of the U-shaped actuating element 7 and interacts with them according to the wedge principle.

The slider 6 can be moved along the guide rails 41, 42 of the carrying element 4 by means of the spindle drive 5 by activating the drive mechanism 50 of the spindle drive 5 and thus rotating the spindle 51 in the one or the other rotational direction so that the spindle nut 52 combing with the spindle 51 and being tightly connected to the slider 6 being restraint-guided along the guiding rails 41, 42 of the carrying element 4 is moved dependent on the rotational direction of the spindle 51 towards the drive mechanism 50 or away from said mechanism and accordingly the slider 6 is translational adjusted in the one or the other direction.

The spindle nut 52 is preferably connected to the slider 6 in a formfitted manner, in particular by pressing into the slider 6, can however also be deformed in one piece out of the slider 6.

Due to the interaction of the slider 6 with the curved ramp section 70 of the actuating element 7, the actuating element 7 is pivoted, when moving the slider 6 along the carrying element 4 by means of the spindle drive 5, abound the swivel bearing 43, 44 such that the distance of the front end of the actuating element 7 to the carrying element 4, that means to the side member 11 of the backrest frame, with which the carrying element 4 is tightly connected, is reduced. Due to the interaction of the slider 6 with the ramp section 70 of the actuating element 7 according to the wedge principle, a translational adjustment of the slider 6 along the guide rails 41, 42 of the carrying element 4 provides therefore a pivot movement of the actuating element 7 about the swivel bearing 43, 44 and thus via the supporting wing 8 being connecting to the actuating element 7 to an adjustment of the geometry and/or hardness or the curvature and thus width of the side bolster 21 according to FIG. 2.

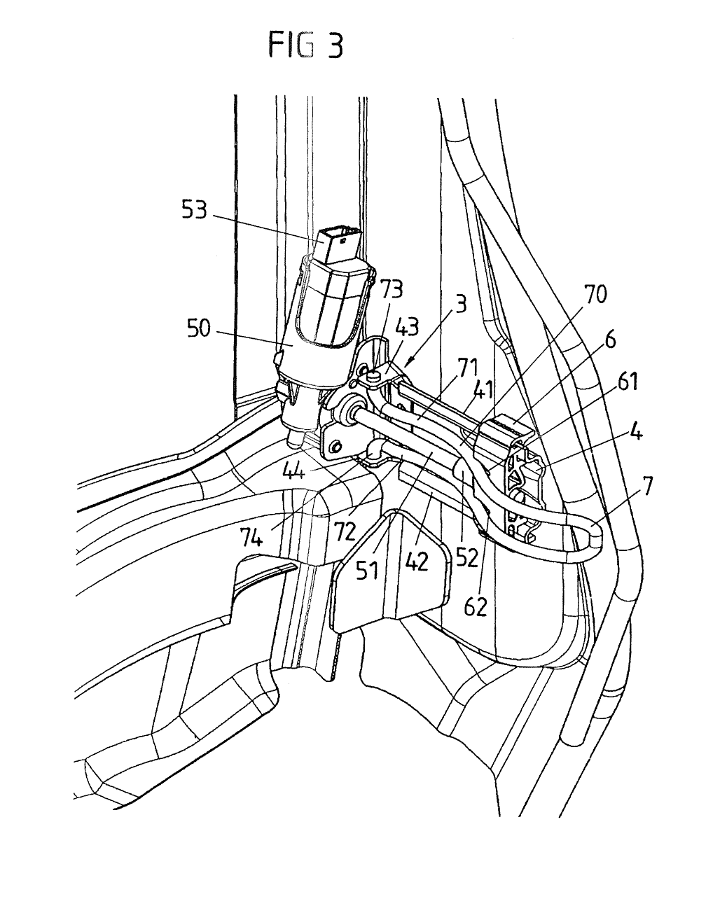

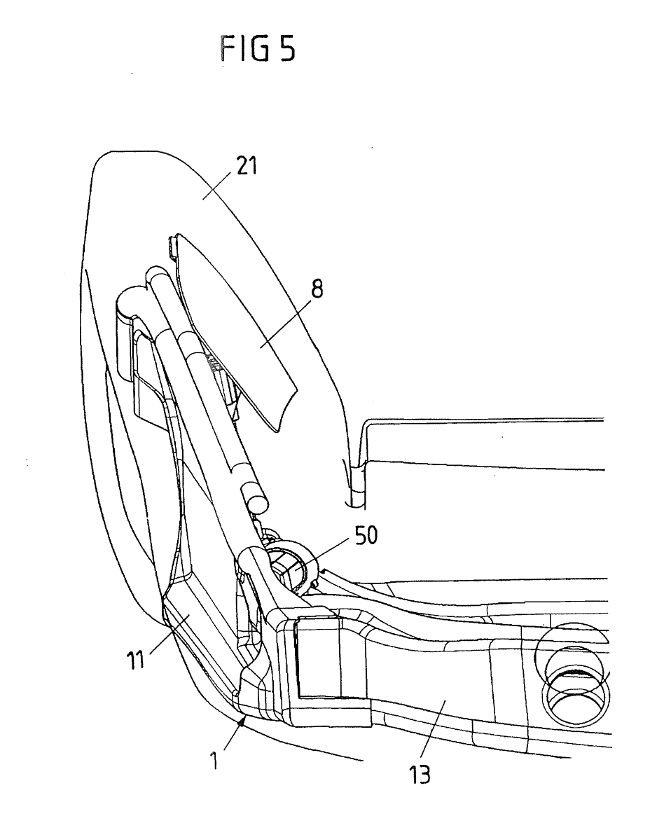

FIG. 3 shows the slider 6 in the area of a frontal end position in respect to the carrying element 4, in which the distance of the actuating element 7 from the carrying element 4 is minimal and accordingly the supporting wing 8 rests tightly against the carrying element or against side member 21 according to FIG. 5.

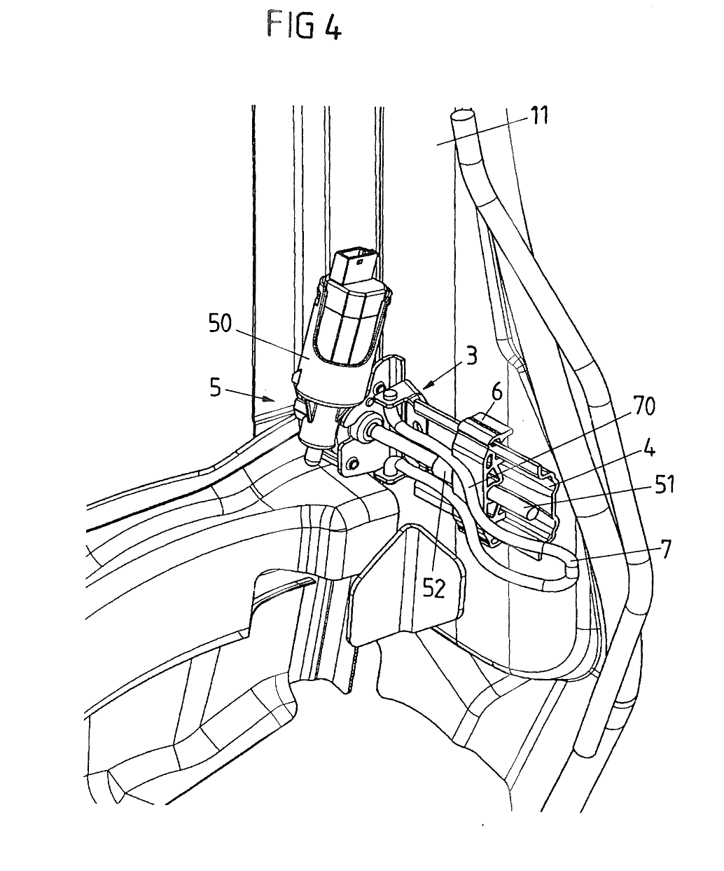

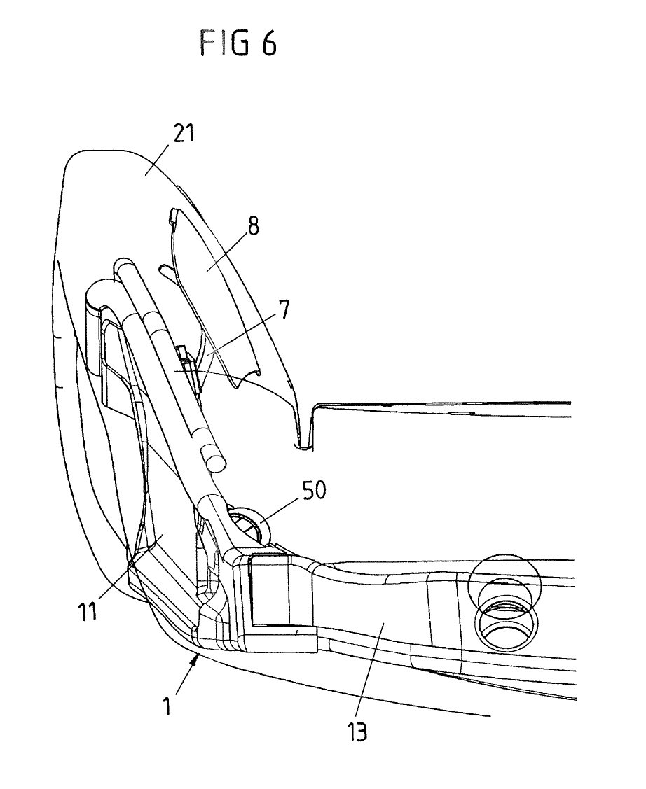

When actuating the spindle drive 5, the slider 6 is positioned according to FIG. 4 in a central area of the carrying element 4 so that by interaction of the slider 6 with the ramp section 70 of the actuating element 7, the actuating element 7 takes up a larger distance from the carrying element 4 and thus according to FIG. 6 the supporting wing 8 is positioned further away from the carrying element or the side member 21 so that the curvature or hardness of the side bolster 21 is enlarged via the supporting wing 8 being connected to the actuating element 7.

Due to the use of identical formed adjustment modules 3 or 3′ on the side bolsters 21, 22 of the backrest, a symmetrical distribution of the geometry and/or hardness or the curvature and thus width of the side bolsters 21, 22 of the backrest is obtained by consistent control of the drive mechanism 50 of the adjustment modules 3, 3′. Such an electric coupling of two symmetrically arranged and identically designed adjustment modules 3, 3′ at the side bolsters 21, 22 of the backrest or the seat bottom of a motor vehicle seat can be omitted when using the adjustment module 3, 3′ for adjusting the geometry and/or hardness or the curvature of a thigh rest, the upper backrest part of a divided backrest as well as a centred lumber adjustment, since only one adjustment module can be applied.

Instead of an electric coupling of identically designed and to each other symmetrically arranged modules 3, 3′ a mechanical coupling can be provided. In this case, the adjustment module 3 comprises a carrying element 4 designed as a cross-traverse, wherein said carrying element extends between the side members 11, 12 of the backrest frame 1 and houses a spindle drive 5, which only comprises a drive mechanism, for instance an electromotive drive mechanism, and a spindle driven by said mechanism with two thread sections with threads having opposite thread pitches, namely a thread section with a left pitch thread and a thread section with a right pitched thread. Each of the two thread sections interact with an assigned internal thread or a spindle nut of sliders, which engage beneath the ramp sections of the assigned actuating elements.

Due to the different pitch of the two thread sections of the spindle, the two sliders are moved, when rotating the spindle depending on the rotational direction of the drive mechanism, in the area of the two side bolsters, in opposite directions so that the supporting wings connected to the respective actuating elements are moved in respect to the centre axis of the motor vehicle seat towards each other or away from each other and accordingly the curvatures of the side bolsters 21, 22 are enlarged or reduced, which has the consequence of a corresponding change of geometry and hardness of the side bolsters.

Depending on arrangement and design of the side bolsters, the geometry of the actuating elements and the configuration of the spindle drive can be designed by for instance using a flexible spindle or reversing gear.

1-16. (canceled)

17. An apparatus for adjusting the hardness and geometry of seating elements of a motor vehicle seat, in particular for adjusting the curvature and/or the width of side bolsters of a seat bottom or a backrest, an upper rest part of a divided backrest, a lumber support or a thigh rest of a seat bottom having supporting wings, the position of which can be changed by means of pivotable actuating elements, wherein the actuating elements are part of an adjustment module for adjusting the seating element, wherein said module comprises a carrying element which can be connected to the seating element and on which the actuating element is pivotably mounted and can be adjusted along a control curve by means of a spindle drive connected to the carrying element.

18. The apparatus according to claim 17, wherein the adjustment module is formed axis symmetrically.

19. The apparatus according to claim 17, wherein the spindle drive comprises a spindle which can be driven by a drive mechanisms, wherein said spindle combs with a spindle nut, which is connected to a slider which is guided translational on the carrying element, wherein on said slider the actuating element being pivotably mounted on the carrying element is supported.

20. The apparatus according to claim 17, wherein the spindle drive comprises a spindle which can be driven by a drive mechanism, wherein said spindle combs with a spindle nut, wherein said spindle nut is connected to the actuating element being translational guided on the carrying element and being pivotably connected to the carrying element, which is supported on a stationary slider.

21. The apparatus according to claim 17, wherein the control curve consists of ramp sections formed on the slider and/or the actuating element.

22. The apparatus according to claim 17, wherein the carrying element comprises at least one guide rail or is connected to at least one guide rail, on which the slider is guided.

23. The apparatus according to claim 17, wherein the actuating element consists of a wire strap having two arms, wherein the ends thereof are pivotably hinged on swivel bearings being connected to the carrying element or being formed on the carrying element.

24. The apparatus according to claim 17, wherein the supporting wings consists of flexible plastic shields, flexible mats, hardenings in the cushion or the side bolsters or the like.

25. The apparatus according to claim 24, comprising a movable connection between the supporting wings and the actuating elements.

26. The apparatus according to claim 25, wherein the movable connection between the supporting wings and the actuating elements is formed as Velcro fastener.

27. The apparatus according to claim 17, wherein the supporting wings are connected via guiding devices to the side bolsters or the stability structure of the seat bottom or the backrest of the motor vehicle seat.

28. The apparatus according to claim 17, wherein each side bolster is connected to an adjusting module having its own drive mechanism of the spindle drive.

29. The apparatus according to claims 17, further comprising an adjusting module for adjusting supporting wings arranged in both side bolsters of the motor vehicle seat by means of a common spindle drive.

30. The apparatus according to claim 29, wherein the carrying element comprises guide rails or is connected to guide rails, on which the slider of the adjusting module are movably guided for adjusting the geometry of right and left seat elements of a motor vehicle seat in directions be opposite to each other.

31. The apparatus according to claims 29, wherein the spindle drive of the adjusting module includes a spindle with two threaded sections with a thread pitch opposite to each other, which comb with two spindle nuts connected in each case to a slider such that the slider can be moved when rotating the spindle in each other opposing directions and pivot the actuating elements about the supporting elements of the swivel bearing via the ramp sections formed on the slider and/or the actuating elements.

32. The apparatus according to claim 17, further comprising a manual or electromotive drive mechanism for the spindle drive of the adjustment module.
